(19) United States
(12) Patent Application Publication
(10) Pub. No.: US 2007/0148533 A1
(43) Pub. Date: Jun. 28, 2007

(54) Batteries

(76) Inventors: David L. Anglin, Brookfield, CT (US); Robert Yoppolo, New Milford, CT (US)

Correspondence Address: FISH & RICHARDSON P.C., P.O. BOX 1022, MINNEAPOLIS, MN, 55440-1022, US

(21) Appl. No.: 11/317,432

(22) Filed: Dec. 23, 2005

(51) Int. Cl. H01M 2/12

(52) U.S. Cl. 429/56; 429/82

(57) ABSTRACT

Batteries are disclosed. In some embodiments, a battery can include a housing including an aperture having an area of at most 0.008 square inch, an anode in the housing, a cathode in the housing, and a membrane. The membrane can cover at least a portion of the aperture, and can include at least one polymer. The membrane can have an area that is at most about 105 percent of the area of the aperture.

### TECHNICAL FIELD

The invention relates to batteries.

### BACKGROUND

Batteries or electrochemical cells are commonly used electrical energy sources. A battery contains a negative electrode, typically called the anode, and a positive electrode, typically called the cathode. The anode contains an active material that can be oxidized; the cathode contains or consumes an active material that can be reduced. The anode active material is capable of reducing the cathode active material. In order to prevent direct reaction of the active material of the anode and the active material of the cathode, the electrodes are electrically isolated from each other by a separator.

When a battery is used as an electrical energy source in a device, electrical contact is made to the anode and the cathode, allowing electrons to flow through the device and permitting the respective oxidation and reduction reactions to occur to provide electrical power. An electrolyte in contact with the anode and the cathode contains ions that flow through the separator between the electrodes to maintain charge balance throughout the battery during discharge.

### SUMMARY

The invention generally relates to batteries including membranes.

In one aspect, the invention features a battery including a housing including an aperture, an anode in the housing, a cathode in the housing, and a membrane covering the aperture. The membrane includes a UV-cured polymer and/or a thermally-cured polymer.

In another aspect, the invention features a battery with a housing including an aperture having an area of at most 0.008 square inch (e.g., at most 0.005 square inch, at most 0.001 square inch, at most 0.0005 square inch, at most 0.0001 square inch), an anode in the housing, a cathode in the housing, and a membrane (e.g., an in situ formed membrane) covering the aperture, the membrane including at least one polymer. The area of the membrane is at most about 105 percent (e.g., at most about 104 percent, at most about 103 percent, at most about 102 percent, at most about 101 percent) of the area of the aperture.

In a further aspect, the invention features a battery including a housing including an aperture, an anode in the housing, a cathode in the housing, and a vent assembly. The vent assembly includes a membrane covering the aperture. The vent assembly does not include a disk.

In an additional aspect, the invention features a method of making a battery including a housing. The method includes applying a polymer to an aperture in the housing, curing the polymer to form a membrane covering the aperture, disposing an anode within the housing, and disposing a cathode within the housing.

In a further aspect, the invention features a method including forming a battery with a housing including an aperture having an area of at most 0.008 square inch (e.g., at most 0.005 square inch, at most 0.001 square inch, at most 0.0005 square inch, at most 0.0001 square inch), an anode in the housing, a cathode in the housing, and a membrane (e.g., an in situ formed membrane) including at least one polymer. The area of the membrane is at most about 105 percent (e.g., at most about 104 percent, at most about 103 percent, at most about 102 percent, at most about 101 percent) of the area of the aperture, and the membrane covers the aperture.

Embodiments can include one or more of the following features.

The battery can include one aperture or can include multiple apertures. The area of the membrane can be at least 100 percent (e.g., at least about 101 percent, at least about 102 percent, at least about 103 percent, at least about 104 percent, at least about 105 percent, at least about 110 percent, at least about 140 percent, at least about 200 percent, at least about 300 percent, at least about 400 percent, at least about 500 percent, at least about 1000 percent, at least about 1500 percent, at least about 2000 percent, at least about 2500 percent) and/or at most about 3000 percent (e.g., at most about 2500 percent, at most about 2000 percent, at most about 1500 percent, at most about 1000 percent, at most about 500 percent, at most about 400 percent, at most about 300 percent, at most about 200 percent, at most about 140 percent, at most about 110 percent, at most about 105 percent, at most about 104 percent, at most about 103 percent, at most about 102 percent, at most about 101 percent) of the area of the aperture. The membrane can be attached (e.g., bonded) to the housing. The membrane can be attached to the housing using an adhesive. The vent assembly may include only a membrane. The vent assembly may not include a disk (e.g., a metallic disk overlying the membrane and/or adjacent to the membrane).

Embodiments can include one or more of the following advantages.

In some embodiments in which a battery evolves gas (e.g., hydrogen gas), some or all of the gas can be released from the battery through the membrane (e.g., by permeating through the membrane, by rupturing the membrane). This release of gas from the battery can limit the likelihood of a substantial increase in the internal pressure of the battery, and can thereby limit the likelihood of harm to a user (e.g., as a result of the battery leaking and/or exploding).

In some embodiments, a membrane can occupy relatively little space in a battery, thereby providing space in the battery for other components (e.g., electrode active materials). In certain embodiments, a battery that includes an aperture and/or a membrane can include a relatively thin insulating seal in its top cap region (e.g., as an alternative to a vent plug or a spring pressure relief plug). The seal can be relatively thin because, for example, the seal may not include and/or be associated with venting components. In some embodiments, a battery including a relatively thin seal can have additional room for other battery components (e.g., electrode active materials). For example, in some embodiments, the battery can have at least about three percent more free volume in it than an otherwise comparable battery having a thicker seal. An increase in the amount of electrode active materials in a battery may, for example, result in enhanced electrochemical performance (e.g., enhanced capacity) by the battery. In some embodiments, a battery including a relatively thin seal may be less expensive to manufacture than a battery including a relatively thick seal.

In some embodiments, a battery including an aperture and/or a membrane can be relatively easily manufactured. As an example, in certain embodiments, the geometry of an aperture can be relatively easily designed to suit a particular battery (e.g., a cylindrical cell, a prismatic cell) and/or selected burst pressure threshold. For example, in some embodiments, a large electrochemical cell (e.g., a cylindrical D battery) can include one or more relatively large apertures in its housing, and a small electrochemical cell (e.g., a cylindrical AAA battery) can include one or more relatively small apertures in its housing. As another example, in certain embodiments, one or more of the characteristics of a membrane (e.g., material, thickness, area, geometry) can be designed to suit a particular battery (e.g., a cylindrical cell, a prismatic cell) and/or selected burst pressure threshold. In some embodiments, a membrane can be relatively flexible. This can, for example, allow the membrane to conform relatively easily to the location in which the membrane is used. For example, the membrane may conform relatively easily to the contours of a battery housing. In certain embodiments, existing battery parts can be relatively easily adapted to include one or more apertures and/or membranes. For example, in some embodiments, the positive terminal, negative terminal, and/or battery housing wall of a battery can be modified to include one or more apertures and/or membranes. In certain embodiments, it can be relatively inexpensive to include an aperture and/or a membrane in a battery.

Other aspects, features, and advantages of the invention are in the drawings, description, and claims.

### DESCRIPTION OF DRAWINGS

FIG. 1A is a cross-sectional view of an embodiment of a battery.

FIG. 1B is a cross-sectional view of a component of the battery of FIG. 1A.

FIG. 1C is a top view of a portion of the component of FIG. 1B.

FIG. 1D is an enlarged perspective view of a portion of the component of FIG. 1B.

FIG. 1E is an enlarged view of region 1E of FIG. 1B.

FIG. 2 is a cross-sectional view of an embodiment of a component of a battery.

FIG. 3 is a cross-sectional view of an embodiment of a component of a battery.

FIG. 4 is a cross-sectional view of an embodiment of a component of a battery.

FIG. 5 is a top view of an embodiment of a component of a battery.

FIG. 6 is a top view of an embodiment of a component of a battery.

FIG. 7 is a top view of an embodiment of a component of a battery.

FIG. 8 is a cross-sectional view of an embodiment of a component of a battery.

FIG. 9 is a cross-sectional view of an embodiment of a component of a battery.

FIG. 10 is a cross-sectional view of an embodiment of a component of a battery.

FIG. 11 is a cross-sectional view of an embodiment of a component of a battery.

FIG. 12A is a perspective view of an embodiment of a component of a battery.

FIG. 12B is a side cross-sectional view of an embodiment of a battery housing containing the component of FIG. 12A.

FIG. 13 is a perspective view of an embodiment of a component of a battery.

### DETAILED DESCRIPTION

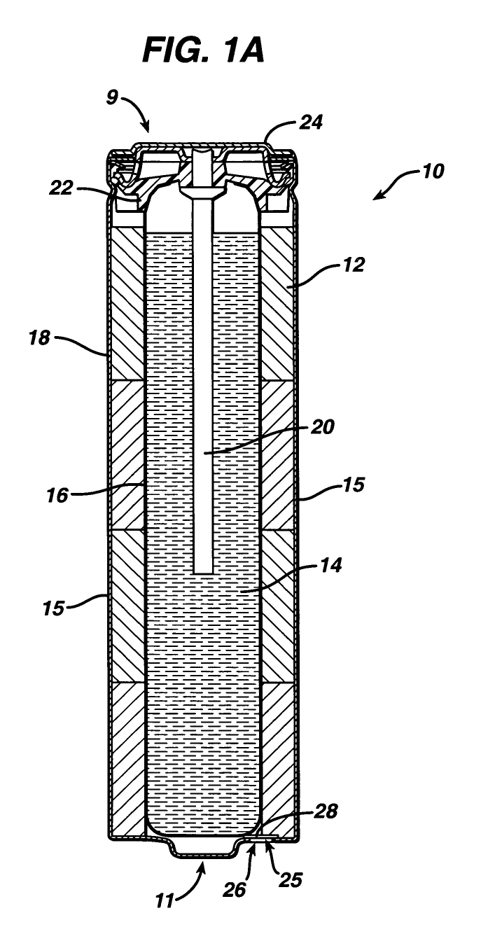

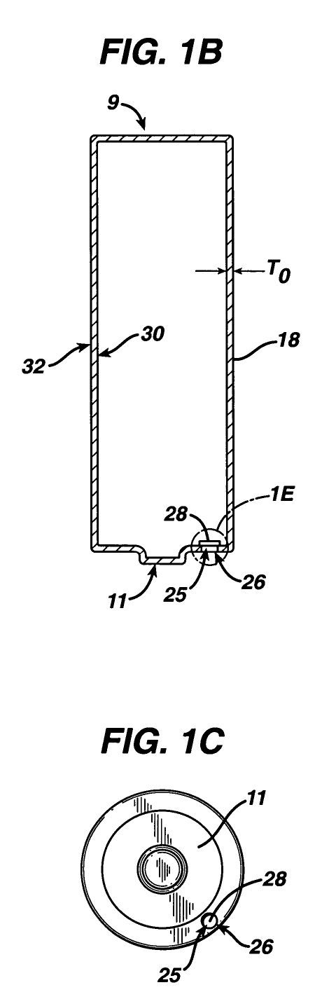

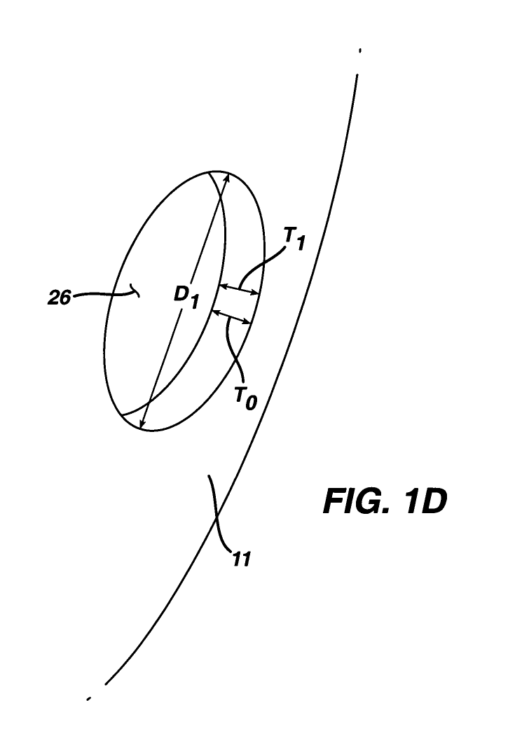

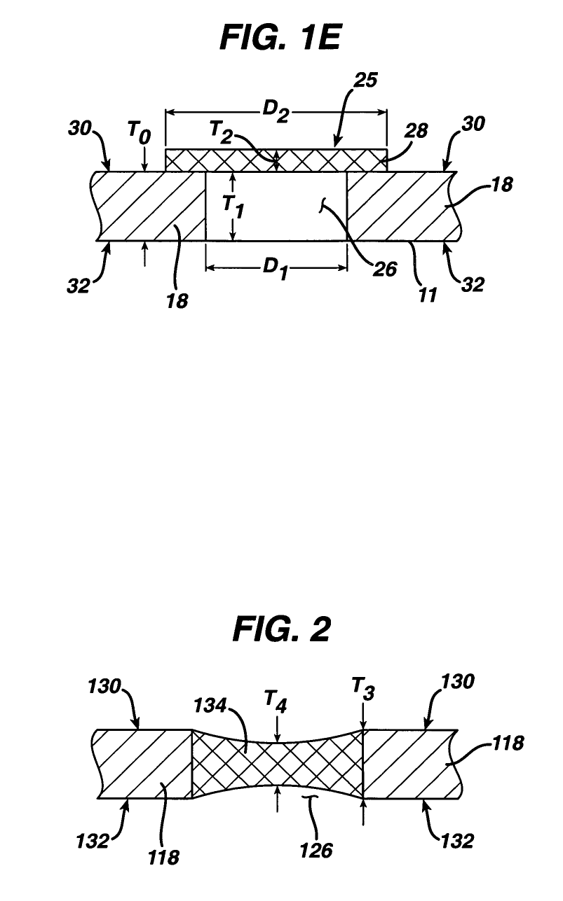

Referring to FIG. 1A, a battery or electrochemical cell 10 has a housing 18 containing a cathode 12, an anode 14, a separator 16 between cathode 12 and anode 14, and a current collector 20. FIG. 1B shows a cross-sectional view of housing 18. Housing 18 is a cylindrical housing, and has an interior surface 30, an exterior surface 32, and a thickness T₀. In some embodiments, thickness. T₀ can be at least 0.18 millimeter and/or at most 0.3 millimeter (e.g., 0.25 millimeter). Cathode 12, which is in contact with housing 18, includes a cathode active material, and anode 14 includes an anode active material. An electrolyte also is dispersed throughout battery 10. Housing 18 includes a cylindrical portion 15, a negative terminal 9, and a positive terminal 11. Negative terminal 9 includes a seal 22, a metal top cap 24, and a current collector 20. Positive terminal 11 is at the end of battery 10 opposite from negative terminal 9. As shown in FIG. 1A, positive terminal 11 includes a circular aperture 26 covered by a vent assembly 25 including a membrane 28. Membrane 28 can, for example, provide for permeation of one or more gases (e.g., hydrogen gas) out of battery 10, and/or can rupture in the event of pressure build-up, thereby relieving the internal pressure of battery 10.

FIG. 1C shows a top view of positive terminal 11, and FIG. 1D shows an enlarged perspective view of aperture 26 (in the absence of membrane 28). As shown in FIG. 1D, aperture 26 has a thickness T₁ equivalent to thickness T₀ of housing 18, and has a diameter D₁. In some embodiments, diameter D₁ can be selected based on the size of battery 10 and/or the selected burst pressure threshold (the pressure at which membrane 28 is designed to rupture) for battery 10. In certain embodiments in which battery 10 is designed to have a relatively high burst pressure threshold (e.g., at least about 1200 psi), diameter D₁ can be relatively small, while in certain embodiments in which battery 10 is designed to have a relatively low burst pressure threshold (e.g., at most about 500 psi), diameter D₁ can be relatively large. In some embodiments, a relatively large cell (e.g., a D battery) may be designed to have a relatively low burst pressure threshold (e.g., about 300 psi), and/or a relatively small cell (e.g., an AAA battery) may be designed to have a relatively high burst pressure threshold (e.g., from about 1200 psi to about 1500 psi).

As diameter D₁ increases, the burst pressure threshold of battery 10 can decrease. In some embodiments, diameter D₁ can be at most about 0.1 inch (e.g., at most 0.07 inch, at most 0.05 inch, at most 0.03 inch, at most 0.01 inch) and/or at least 0.005 inch (e.g., at least 0.01 inch, at least 0.03 inch, at least 0.05 inch, at least 0.07 inch).

As the area of aperture 26 increases, the burst pressure threshold of battery 10 can decrease, and/or the rate of permeation of gas (e.g., hydrogen gas) through membrane 28 can increase. In some embodiments, aperture 26 can have an area of at most 0.008 square inch (e.g., at most 0.005 square inch, at most 0.001 square inch, at most 0.0005 square inch, at most 0.0001 square inch, at most 0.00005 square inch) and/or at least 0.00002 square inch (e.g., at least 0.00005 square inch, at least 0.0001 square inch, at least 0.0005 square inch, at least 0.001 square inch, at least 0.005 square inch).

Aperture 26 can be formed in housing 18 using, for example, a laser and/or a drill.

Referring to FIG. 1E, membrane 28, which is shown as a film, is bonded to interior surface 30 of housing 18, and covers aperture 26. Membrane 28 can be permeable to hydrogen gas. This permeability to hydrogen gas can allow membrane 28 to help relieve pressure buildup within housing 18 by gradually releasing hydrogen gas as it is generated. In certain embodiments, membrane 28 can be adapted to burst when the pressure within housing 18 reaches a certain threshold (e.g., as a result of hydrogen gas build-up). By bursting at the threshold pressure, membrane 28 can limit the likelihood that battery 10 will explode.

In some embodiments, the area of membrane 28 can be greater than the area of aperture 26. This can, for example, allow for relatively good contact and/or adhesion between membrane 28 and interior surface 30 of housing 18. This relatively good contact and/or adhesion may limit the likelihood of membrane 28 rupturing prematurely in the event of pressure build-up within housing 18. In certain embodiments, the area of membrane 28 can be at least about 140 percent (e.g., at least about 200 percent, at least about 300 percent, at least about 400 percent, at least about 500 percent, at least about 1000 percent, at least about 1500 percent, at least about 2000 percent, at least about 2500 percent) and/or at most about 3000 percent (e.g., at most about 2500 percent, at most about 2000 percent, at most about 1500 percent, at most about 1000 percent, at most about 500 percent, at most about 400 percent, at most about 300 percent, at most about 200 percent) of the area of aperture 26.

In some embodiments, membrane 28 can have an area of at most 0.04 square inch (e.g., at most 0.03 square inch, at most 0.02 square inch, at most 0.01 square inch, at most 0.005 square inch, at most 0.001 square inch, at most 0.0005 square inch, at most 0.0001 square inch) and/or at least 0.00002 square inch (e.g., at least 0.0001 square inch, at least 0.0005 square inch, at least 0.001 square inch, at least 0.005 square inch, at least 0.01 square inch, at least 0.02 square inch, at least 0.03 square inch).

As shown in FIG. 1E, membrane 28 has a thickness T₂ and a diameter D₂. Thickness T₂ can be selected, for example, based on the desired burst pressure threshold for battery 10, and/or the desired amount of gas permeability for membrane 28. In some embodiments, as thickness T₂ increases, the burst pressure threshold for battery 10 can also increase. In certain embodiments, as thickness T₂ decreases, the permeability of membrane 28 to one or more gases (e.g., hydrogen gas) can increase. In some embodiments, thickness T₂ can be at least 0.00005 inch (e.g., at least 0.0001 inch, at least 0.0005 inch, at least 0.001 inch, at least 0.002 inch, at least 0.004 inch, at least 0.006 inch, at least 0.008 inch, at least 0.01 inch, at least 0.015 inch, at least 0.02 inch, at least 0.025 inch) and/or at most 0.03 inch (e.g., at most 0.025 inch, at most 0.02 inch, at most 0.015 inch, at most 0.01 inch, at most 0.008 inch, at most 0.006 inch, at most 0.004 inch, at most 0.002 inch, at most 0.001 inch, at most 0.0005 inch, at most 0.0001 inch). Membrane 28 can have a thickness T₂ of, for example, 0.00025 inch, 0.0005 inch, 0.001 inch, 0.002 inch, or 0.012 inch.

Diameter D₂ can be selected, for example, based on the desired extent of coverage of aperture 26 by membrane 28. In some embodiments, diameter D₂ can be at least 0.04 inch (e.g., at least 0.06 inch, at least 0.08 inch, at least 0.1 inch, at least 0.15 inch) and/or at most 0.2 inch (e.g., at most 0.15 inch, at most 0.1 inch, at most 0.08 inch, at most 0.06 inch). In certain embodiments, diameter D₂ can be at least 0.007 inch longer than diameter D₁.

As described above, one or more of the characteristics (e.g., thickness T₂) of membrane 28 can be selected so that membrane 28 bursts at a desired threshold pressure. In some embodiments, membrane 28 can be adapted to burst when the pressure within housing 18 of battery 10 is at least about 25 psi (e.g., at least about 50 psi, at least about 100 psi, at least about 200 psi, at least about 300 psi, at least about 400psi, at least about 500 psi, at least about 750 psi, at least about 1000 psi, at least about 1250 psi, at least about 1500 psi, at least about 2000 psi, at least about 2500 psi) and/or at most about 3000 psi (e.g., at most about 2500 psi, at most about 2000 psi, at most about 1500 psi, at most about 1250 psi, at most about 1000 psi, at most about 750 psi, at most about 500 psi, at most about 400 psi, at most about 100 psi, at most about 50 psi). In certain embodiments, an AAA battery can have a burst pressure threshold of from about 1000 psi to about 2000 psi, an AA battery can have a burst pressure threshold of from about 500 psi to about 1500 psi, a C battery can have a burst pressure threshold of from about 200 psi to about 600 psi, and/or a D battery can have a burst pressure threshold of from about 100 psi to about 400 psi.

Membrane 28 can be formed of any of a number of different materials. In some embodiments, membrane 28 can include (e.g., can be formed of) one or more polymers. Examples of polymers include polysulfones, polyethylenes, polypropylenes, polyamides, polyimides, and polyesters (e.g., polyethylene terephthalate (PET)). In certain embodiments, membrane 28 can include INTEGRAL 625 two-layer adhesive film (from Dow Chemical Co.).

Membrane 28 can be attached to interior surface 30 of housing 18 in any of a number of different ways.

In some embodiments, membrane 28 can be bonded to interior surface 30 using one or more epoxy adhesives. An example of an epoxy adhesive is Millennium EN-239-2™ epoxy adhesive (from Resin Technology Group, LLC, South Easton, Mass.), a cationically-cured, UV-initiated epoxy adhesive. In certain embodiments, membrane 28 can be bonded to interior surface 30 using one or more sealants, such as SpecSeal® solution-based nylon sealant in toluene or isopropanol solvent (from Specialty Chemicals, Cleveland, Tenn.) and/or Korite asphalt-based sealant in toluene solvent (from Specialty Chemicals, Cleveland, Tenn.). In some embodiments, membrane 28 can be bonded to interior surface 30 using a thermally cured two-part epoxy adhesive such as a blend of D.E.R. 325 epoxy resin (from Dow Plastics) and a polyfunctional amine or amidoamine (e.g., Ancamide™2426 amidoamine epoxy curing agent, from Air Products). In certain embodiments, membrane 28 can be bonded to interior surface 30 using a thermally cured blend of D.E.R. 325 epoxy resin (from Dow Plastics) and Ancamide™350A polyamide epoxy curing agent (from Air Products). In some embodiments, membrane 28 can be bonded to interior surface 30 using a cyanoacrylate adhesive.

In some embodiments, membrane 28 can be bonded to interior surface 30 by heating membrane 28 and/or the area of contact between membrane 28 and interior surface 30. In certain embodiments, membrane 28 can be attached to interior surface 30 of housing 18 before any or all of the other cell components have been added into housing 18. In some embodiments, aperture 26 can first be formed in housing 18, membrane 28 can then be added over aperture 26, and the remainder of battery 10 can be assembled. For example, cathode pellets can be placed in housing 18 and compacted to form cathode 12, separator 16 can be placed in housing 18, anode 14 can be added into housing 18, housing 18 can be filled with electrolyte, the components of negative terminal 9 can be added, and metal top cap 24 can be crimped to seal the system, forming battery 10. In certain embodiments, one or more of the components that are added into housing 18 can help to seal membrane 28 against housing 18. For example, the compaction of the cathode pellets can cause one or more of the cathode pellets to press down upon membrane 28, thereby pressing membrane 28 against housing 18. As shown in FIG. 1A, cathode 12 rests on a portion of membrane 28, and thereby helps to seal membrane 28 against housing 18. While FIG. 1A shows a cathode resting on a portion of a membrane, in some embodiments, a membrane can be disposed entirely underneath a cathode. The cathode can, for example, help to hold the membrane in place by pressing the membrane against the battery housing.

In some embodiments, membrane 28 can have relatively low elastic modulus. This can, for example, allow membrane 28 to recover its shape relatively easily after stretching. In certain embodiments, membrane 28 can have an elastic modulus of at most about 1,500,000 psi (e.g., at most about 1,000,000 psi, at most about 500,000 psi, at most about 100,000 psi, at most about 50,000 psi, at most about 10,000 psi, at most about 5,000 psi, at most about 2,500 psi) and/or at least about 1,800 psi (e.g., at least about 2,500 psi, at least about 5,000 psi, at least about 10,000 psi, at least about 50,000 psi, at least about 100,000 psi, at least about 500,000 psi, at least about 1,000,000 psi). In some embodiments (e.g., some embodiments in which membrane 28 includes INTEGRAL 625 two-layer adhesive film (from Dow Chemical Co.)), membrane 28 can have an elastic modulus (e.g., a secant modulus) of 2,100 psi. In certain embodiments (e.g., certain embodiments in which membrane 28 includes one or more polysulfones and/or polyimides), membrane 28 can have an elastic modulus of about 400,000 psi. In some embodiments (e.g., some embodiments in which membrane 28 includes polyethylene terephthalate (PET)), membrane 28 can have an elastic modulus of about 800,000 psi (e.g., when membrane 28 is a balanced film) or 1,300,000 psi (e.g., when membrane 28 is tensilized). The elastic modulus of a membrane can be measured using, for example, ASTM D882.

In certain embodiments, membrane 28 can be relatively stable in alkaline conditions. For example, membrane 28 may be relatively stable in the presence of an alkaline electrolyte (e.g., potassium hydroxide solution, sodium hydroxide solution). The stability of membrane 28 in the presence of an alkaline electrolyte can be evaluated, for example, by submerging a test film of membrane 28 material in an alkaline (e.g., KOH) solution under mild heat (e.g., from about 50° C. to about 60° C.) for one week, and then measuring the mechanical properties of the test film to determine whether any of the mechanical properties have changed. If the mechanical properties have changed significantly, then membrane 28 may be considered to be relatively mechanically unstable in the presence of the alkaline electrolyte. In certain embodiments, the test film can be weighed prior to being tested, and can be weighed again after the test film has been submerged in an alkaline solution under mild heat for one week. If the weight of the film has decreased significantly (e.g., by more than 0.5 percent), then membrane 28 may be considered to be relatively chemically unstable in the presence of the alkaline electrolyte.

In some embodiments, membrane 28 can have a relatively high tensile strength. The tensile strength of membrane 28 can be measured, for example, using ASTM D638. In certain embodiments, membrane 28 can have a tensile strength of at least about 1,000 psi (e.g., at least about 5,000 psi, at least about 10,000 psi, at least about 15,000 psi, at least about 20,000 psi) and/or at most about 25,000 psi (e.g., at most about 20,000 psi, at most about 15,000 psi, at most about 10,000 psi, at most about 5,000 psi). In some embodiments (e.g., some embodiments in which membrane 28 includes INTEGRAL 625 two-layer adhesive film (from Dow Chemical Co.)), membrane 28 can have a tensile strength of 3,000 psi. In certain embodiments (e.g., certain embodiments in which membrane 28 includes one or more polysulfones), membrane 28 can have a tensile strength of 11,000 psi. In some embodiments (e.g., some embodiments in which membrane 28 includes one or more polyimides), membrane 28 can have a tensile strength of 21,000 psi.

In certain embodiments, membrane 28 can have relatively good shape persistence. As a result, membrane 28 may be able to retain its shape even as the pressure within housing 18 increases.

While batteries including film membranes have been described, in some embodiments, a battery alternatively or additionally can include at least one other type of membrane. For example, FIG. 2 shows a membrane 134 (e.g., an in situ formed membrane) in the form of a seal that fills an aperture 126 in a battery housing 118 having an interior surface 130 and an exterior surface 132. Membrane 134 is bonded to a section of housing 118 that defines aperture 126. In certain embodiments, membrane 134 can be permeable to hydrogen gas. This permeability to hydrogen gas can, for example, allow membrane 134 to relieve pressure buildup within housing 118 by gradually releasing the hydrogen gas. In some embodiments, membrane 134 can be adapted to burst at a predetermined pressure, thus limiting the likelihood that housing 118 will explode (e.g., as a result of hydrogen gas build-up).

Membrane 134 may, for example, have one or more of the same features (e.g., a relatively low elastic modulus) as membrane 28. In some embodiments, membrane 134 can have a relatively low profile and/or can occupy a relatively small amount of space within housing 118. As a result, membrane 134 can provide room for other components, such as electrode active materials, within housing 118. As the amount of electrode active material in a battery increases, the battery may exhibit enhanced electrochemical performance.

Membrane 134 has an area that is equal to the area of aperture 126. Aperture 126 may have one or more of the same features (e.g., area) as aperture 26 (FIG. 1D). As shown in FIG. 2, membrane 134 has a variable thickness. For example, the thickness T₃ of membrane 134 at the point of contact between membrane 134 and housing 118 is greater than the thickness T₄ of membrane 134 at the center of membrane 134. The variable thickness of membrane 134 can provide membrane 134 with a relatively high bonding strength, while still allowing some or all of membrane 134 to be permeable to hydrogen gas. The relatively high bonding strength of membrane 134 can limit the likelihood that membrane 134 will become detached from housing 118 in the event of pressure buildup.

In some embodiments, membrane 134 can have a shear strength of about 6000 psi. In certain embodiments, the material out of which membrane 134 is formed can have a specific gravity of about 1.16.

One or more of the characteristics (e.g., thickness) of membrane 134 can be selected so that membrane 134 is adapted to burst once the pressure within housing 118 has reached a certain level. In certain embodiments, membrane 134 can be adapted to burst at one of the pressures provided above with reference to membrane 28.

In some embodiments, membrane 134 can be directly bonded to the section of housing 118 that defines aperture 126 (i.e., without using any adhesive and/or bonding agent). In certain embodiments, direct bonding of membrane 134 to housing 118 can result in relatively strong adhesion between membrane 134 and housing 118 and/or ease of manufacture.

Membrane 134 can be formed of one or more materials. In certain embodiments, membrane 134 can include at least one polymer. In some embodiments, membrane 134 can include oxetane and/or at least one epoxy resin. In certain embodiments, membrane 134 can include an oxetane-based material. In some embodiments, membrane 134 can include (e.g., can be formed of) Millennium EN-239-2™ epoxy adhesive (from Resin Technology Group, LLC, South Easton, Mass.).

Membrane 134 can be formed in any of a number of different ways. In certain embodiments, membrane 134 can be formed separately from housing 118, and can thereafter be attached to housing 118. In some embodiments, membrane 134 can be an in situ formed membrane, such that membrane 134 is formed at the location of aperture 126. As an example, membrane 134 can initially be formed in aperture 126 as a liquid polymer coating that can form a meniscus across aperture 126. The liquid polymer coating can be formed of one or more polymers that are not dissolved in a solvent. In certain embodiments, the liquid polymer coating can have a viscosity of at least about 500 cps (e.g., at least about 1,000 cps, at least about 5,000 cps, at least about 10,000 cps, at least about 15,000 cps) and/or at most about 20,000 cps (e.g., at most about 15,000 cps, at most about 10,000 cps, at most about 5,000 cps, at most about 1,000 cps) at a temperature of about 25° C. For example, in some embodiments, the liquid polymer coating can have a viscosity of about 6,800 cps at about 25° C. The viscosity of a liquid polymer coating can be measured, for example, using an Ubbelohde suspended level viscometer. The liquid polymer coating can then be cured (e.g., using ultraviolet (UV) radiation, visible light, heat, and/or electron beam sources). In certain embodiments, the liquid polymer coating can be cured by exposure to UV radiation having a wavelength of from about 230 nanometers to about 500 nanometers (e.g., about 375 nanometers) and/or an intensity of greater than 0.2 J/cm². In some embodiments, a Fusion F300 (300 Watt/inch) UV curing system (from Fusion Systems UV Inc., Gaithersburg, MD) can be used to cure the liquid polymer coating to form membrane 134. The Fusion F300 UV curing system can be set at, for example, a conveyor belt speed of about five feet per minute. In some embodiments, the liquid polymer coating can be cured by exposure to a temperature of at least about 25° C. (e.g., at least about 60° C., at least about 100° C.) and/or at most about 150° C. (e.g., at most about 100° C., at most about 60° C.). For example, the liquid polymer coating may be cured by exposure to a temperature of from 60° C. to 150° C. Membrane 134 be formed at the location of aperture 126 prior to, during, and/or after battery assembly.

While membrane 134 has an area that is equal to the area of aperture 126, in some embodiments, a membrane (e.g., a membrane that is in the form of a seal) can have an area that is larger than the area of the aperture being covered by the membrane. For example, the area of the membrane relative to the area of the aperture being covered by the membrane can be within the range provided above with reference to membrane 28. Thus, the membrane may fill the aperture, while also extending beyond the dimensions of the aperture (e.g., along the interior and/or exterior surfaces of the battery housing). In certain embodiments, a membrane (e.g., a membrane that is formed by curing a UV-curable polymer over an aperture in a battery housing) can have an area that is at most about 105 percent (e.g., at most about 104 percent, at most about 103 percent, at most about 102 percent, at most about 101 percent) of the area of the aperture being covered by the membrane. The membrane can occupy relatively little space, while also covering the aperture.

A battery housing such as housing 118 or housing 118 can be formed of one or more different materials. In some embodiments, a battery housing can include one or more metals and/or metal alloys, such as nickel, nickel-plated steel (e.g., nickel-plated cold-rolled steel), stainless steel, aluminum-clad stainless steel, aluminum, and/or aluminum alloys. In certain embodiments, a battery housing can include one or more plastics, such as polyvinyl chloride, polypropylene, polysulfones, acrylonitrile butadiene styrene (ABS), and/or polyamides.

A cathode such as cathode 12 can include at least one (e.g., two, three) cathode active material. In some embodiments, a cathode can further include at least one conductive aid and/or at least one binder. An electrolyte also is dispersed through the cathode. The weight percentages provided herein with respect to the components of a cathode are determined after the electrolyte has been dispersed through the cathode.

In some embodiments, the cathode active material can be a manganese oxide, such as manganese dioxide (MnO₂). The manganese dioxide can be electrolytically-synthesized MnO₂ (EMD), chemically-synthesized MnO₂ (CMD), or a blend of EMD and CMD. Distributors of manganese dioxides include Kerr-McGee Corp. (manufacturer of, e.g., Trona D and high-power EMD), Tosoh Corp., Delta Manganese, Delta EMD Ltd., Mitsui Chemicals, ERACHEM, and JMC. In certain embodiments, a cathode can include from about 80 percent by weight to about 94 percent by weight (e.g., from about 82 percent by weight to about 86 percent by weight) manganese dioxide (e.g., EMD).

Other examples of cathode active materials include copper oxides (e.g., cupric oxide (CuO), cuprous oxide (Cu₂O)); copper hydroxides (e.g., cupric hydroxide (Cu(OH)₂), cuprous hydroxide (Cu(OH))); cupric iodate (Cu(IO₃)₂); AgCuO₂; LiCuO₂; Cu(OH)(IO₃); Cu₂H(IO₆); copper-containing metal oxides or chalcogenides; copper halides (e.g., CuCl₂); and/or copper manganese oxides (e.g., Cu(MnO₄)₂). The copper oxides can be stoichiometric (e.g., CuO) or non-stoichiometric (e.g., CUOₓ, where 0.5≦x≦1.5). Another example of a cathode active material is Cu₆InO₈Cl.

Further examples of cathode active materials include cathode active materials that include nickel, such as a nickel oxyhydroxide (NiOOH). The nickel oxyhydroxide can include, for example, a beta-nickel oxyhydroxide, a cobalt oxyhydroxide-coated beta-nickel oxyhydroxide, a gamma-nickel oxyhydroxide, a cobalt oxyhydroxide-coated gamma-nickel oxyhydroxide, a solid solution of a beta-nickel oxyhydroxide and a gamma-nickel oxyhydroxide, or a cobalt oxyhydroxide-coated solid solution of a beta-nickel oxyhydroxide and a gamma-nickel oxyhydroxide.

Additional examples of cathode active materials include cathode active materials including a pentavalent bismuth-containing metal oxide.

In certain embodiments, a cathode can be porous. A porous cathode can include, for example, one or more of the above-described cathode active materials (e.g., EMD, NiOOH).

The conductive aid can increase the electronic conductivity of cathode 12. An example of a conductive aid is carbon particles. The carbon particles can be any of the conventional carbon particles used in cathodes. The carbon particles can be, for example, graphite particles. Graphite particles can be synthetic, non-synthetic, or a blend of synthetic and non-synthetic, and they can be expanded or non-expanded. In certain embodiments, the graphite particles in a cathode can be non-synthetic, non-expanded graphite particles. In such embodiments, the graphite particles can have an average particle size of less than about 20 microns (e.g., from about two microns to about 12 microns, from about five microns to about nine microns), as measured using a Sympatec HELIOS analyzer. Graphite particles can be obtained from, for example, Brazilian Nacional de Grafite (Itapecirica, MG Brazil (MP-0702X)) or Chuetsu Graphite Works, Ltd. (Chuetsu grades WH-20A and WH-20AF).of Japan. A cathode may include for example, from about three percent to about nine percent (e.g., from about four percent to about seven percent) carbon particles by weight. In some embodiments, a cathode can include from about four percent to about nine percent (e.g., from about four percent to about 6.5 percent) graphite particles by weight.

Another example of a conductive aid is carbon fibers, such as those described in Luo et al., U.S. Pat. No. 6,858,349, and in Anglin, U.S. Patent Application Publication No. US 2002/0172867 A1, published on Nov. 21, 2002, and entitled “Battery Cathode”. In some embodiments, a cathode can include less than about two percent by weight (e.g., less than about 1.5 percent by weight, less than about one percent by weight, less than about 0.75 percent by weight, less than about 0.5 percent by weight), and/or more than about 0.1 percent by weight (e.g., more than about 0.2 percent by weight, more than about 0.3 percent by weight, more than about 0.4 percent by weight, more than about 0.45 percent by weight) carbon fibers.

In certain embodiments, a cathode can include from about one percent by weight to about 10 percent by weight of one or more total conductive aids.

A cathode can be made by coating a cathode material onto a current collector, and drying and then calendering the coated current collector. The cathode material can be prepared by mixing the cathode active material together with other components, such as a binder, solvent/water, and a carbon source. For example, a cathode active material such as MnO₂ may be combined with carbon (e.g., graphite, acetylene black), and mixed with small amount of water to form a cathode slurry. A current collector can then be coated with the cathode slurry to form the cathode.

Examples of binders include polyethylene powders, polyacrylamides, Portland cement and fluorocarbon resins, such as polyvinylidenefluoride (PVDF) and polytetrafluoroethylene (PTFE). An example of a polyethylene binder is sold under the trade name Coathylene HA:1681 (available from Hoechst). A cathode may include, for example, up to about two percent binder by weight (e.g., up to about one percent binder by weight). In certain embodiments, a cathode can include from about 0.1 percent to about two percent (e.g., from about 0.1 percent to about one percent) binder by weight.

A cathode can include other additives. Additives are disclosed, for example, in Mieczkowska et al., U.S. Pat. No. 5,342,712. In some embodiments, a cathode can include titanium dioxide (TiO₂). In certain embodiments, a cathode can include from about 0.1 percent to about two percent (e.g., from about 0.2 percent to about two percent) TiO₂ by weight.

Cathodes (e.g., cathode active materials) are described, for example, in Durkot et al., U.S. Patent Application Publication No. US 2004/0237293 A1, published on Dec. 2, 2004, and entitled “Alkaline Cell With Flat Housing and Nickel Oxyhydroxide Cathode”; Durkot et al., U.S. Patent Application Publication No. US 2004/0197656 A1, published on Oct. 7, 2004, and entitled “Alkaline Battery Including Nickel Oxyhydroxide Cathode and Zinc Anode”; Bowden et al., U.S. Patent Application Publication No. US 2004/0076881 A1, published on Apr. 22, 2004, and entitled “Method of Making a Battery”; Eylem et al., U.S. Patent Application Publication No. US 2005/0136328 A1, published on Jun. 23, 2005, and entitled “Battery Cathode”; Christian et al., U.S. Patent Application Publication No. US 2004/0043292 A1, published on Mar. 4, 2004, and entitled “Alkaline Battery Including Nickel Oxyhydroxide Cathode and Zinc Anode”; Christian et al., U.S. Patent Application Publication No. US 2004/0202931 A1, published on Oct. 14, 2004, and entitled “Preparation of Nickel Oxyhydroxide”; Eylem et al., U.S. Patent Application Publication No. US 2005/0058903 A1, published on Mar. 17, 2005, and entitled “Primary Alkaline Battery Containing Bismuth Metal Oxide”; Wang et al., U.S. Patent Application Publication No. US 2005/0058902 A1, published on Mar. 17, 2005, and entitled “Primary Alkaline Battery Containing Bismuth Metal Oxide”; and Kelsey et al., U.S. Pat. No. 6,207,322.

The electrolyte that is dispersed through a cathode (and/or the electrolyte used in the rest of a battery) can be any of the electrolytes used in batteries. In some embodiments, a cathode can include from about five percent to about 10 percent (e.g., from about six percent to about seven percent) electrolyte by weight. The electrolyte can be aqueous or non-aqueous. An aqueous electrolyte can be an alkaline solution, such as an aqueous hydroxide solution (e.g., LiOH, NaOH, KOH), or a mixture of hydroxide solutions (e.g., NaOH/KOH). For example, the aqueous hydroxide solution can include from about 33 percent by weight to about 40 percent by weight of the hydroxide material, such as about 9N KOH (about 37 percent by weight KOH). In some embodiments, the electrolyte can also include up to about four percent by weight (e.g., about two percent by weight) of zinc oxide.

The electrolyte can include other additives. As an example, the electrolyte can include a soluble material (e.g., an aluminum material) that reduces (e.g., suppresses) the solubility of the cathode active material in the electrolyte. In certain embodiments, the electrolyte can include one or more of the following: aluminum hydroxide, aluminum oxide, alkali metal aluminates, aluminum metal, alkali metal halides, alkali metal carbonates, or mixtures thereof. Electrolyte additives are described, for example, in Eylem et al., U.S. Patent Application Publication No. US 2004/0175613 A1, published on Sep. 9, 2004, and entitled “Battery”.

An anode such as anode 14 can be formed of any of the zinc materials used in battery anodes. For example, an anode can be a zinc gel that includes zinc metal particles, a gelling agent, and minor amounts of additives, such as gassing inhibitor. In addition, a portion of the electrolyte is dispersed throughout the anode.

The zinc particles can be any of the zinc particles (e.g., zinc fines) used in gel anodes. Examples of zinc particles include those described in Durkot et al., U.S. Pat. No.6,284,410, and in Durkot et al., U.S. Pat. No. 6,521,378. In certain embodiments, anode 14 can include spherical zinc particles. Spherical zinc particles are described, for example, in Costanzo et al., U.S. Patent Application Publication No. US 2004/0258995 A1, published on Dec. 23, 2004, and entitled “Anode for Battery”. The zinc particles can be a zinc alloy (e.g., containing a few hundred parts per million of indium and bismuth). An anode may include, for example, from about 40 percent to about 90 percent (e.g., from about 67 percent to about 80 percent) zinc particles by weight.

Examples of gelling agents include polyacrylic acids, grafted starch materials, salts of polyacrylic acids, polyacrylates, carboxymethylcellulose or combinations thereof. Examples of polyacrylic acids include Carbopol 940 and 934 (available from Noveon Inc.) and Polygel 4P (available from 3V). An example of a grafted starch material is Waterlock A221 (available from Grain Processing Corporation, Muscatine, Iowa.). An example of a salt of a polyacrylic acid is Alcosorb G1 (available from Ciba Specialties). An anode may include, for example, from about 0.1 percent to about one percent gelling agent by weight.

Gassing inhibitors can be inorganic materials, such as bismuth, tin, lead and indium. Alternatively, gassing inhibitors can be organic compounds, such as phosphate esters, ionic surfactants or nonionic surfactants. Examples of ionic surfactants are disclosed, for example, in Chalilpoyil et al., U.S. Pat. No. 4,777,100 .

A separator such as separator 16 can be formed of any of the standard separator materials used in electrochemical cells (e.g., alkaline cells). For example, a separator can be formed of polypropylene (e.g., non-woven polypropylene or microporous polypropylene), polyethylene, polytetrafluoroethylene, a polyamide (e.g., a nylon), a polysulfone, a polyvinyl chloride, or combinations thereof. In some embodiments, a separator can include a layer of cellophane combined with a layer of a non-woven material. The non-woven material can include, for example, polyvinyl alcohol and/or rayon.

A seal such as seal 22 can be made of, for example, a polymer (e.g., nylon).

A cap such as cap 24 can be made of, for example, a metal or a metal alloy, such as aluminum, nickel, titanium, or steel.

In some embodiments, a battery can include a hydrogen recombination catalyst to lower the amount of hydrogen gas that may be generated in the cell by the anode (e.g., when the anode includes zinc). Hydrogen recombination catalysts are described, for example, in Davis et al., U.S. Pat. No. 6,500,576, and in Kozawa, U.S. Pat. No. 3,893,870. Alternatively or additionally, a battery can be constructed to include pressure-activated valves or vents, such as those described in Tomantschger et al., U.S. Pat. No. 5,300,371.

Weight percentages of battery components provided herein are determined after the electrolyte solution has been dispersed in the battery.

A battery such as battery 10 can be a primary electrochemical cell or a secondary electrochemical cell. Primary cells are meant to be discharged (e.g., to exhaustion) only once, and then discarded. Primary cells are not intended to be recharged. Primary cells are described, for example, in David Linden, Handbook of Batteries (McGraw-Hill, 2d ed. 1995). Secondary electrochemical cells can be recharged for many times (e.g., more than fifty times, more than a hundred times, or more). In some embodiments, secondary cells can include relatively robust separators, such as separators that have many layers and/or separators that are relatively thick. Secondary cells can also be designed to accommodate for changes, such as swelling, that can occur in the cells. Secondary cells are described, for example, in Falk & Salkind, “Alkaline Storage Batteries”. John Wiley & Sons, Inc. 1969, and in Virloy et al., U.S. Pat. No. 345,124.

A battery such as battery 10 can be of any of a number of different voltages (e.g., 1.5 V, 3.0 V, 4.0 V), and/or can be, for example, a AA, AAA, AAAA, C, or D battery. While battery 10 is cylindrical, in some embodiments, a battery can be non-cylindrical. For example, a battery can be a coin cell, a button cell, a wafer cell, or a racetrack-shaped cell. In some embodiments, a battery can be prismatic. In certain embodiments, a battery can have a rigid laminar cell configuration or a flexible pouch, envelope or bag cell configuration. In some embodiments, a battery can have a spirally wound configuration, or a flat plate configuration. Batteries are described, for example, in Bedder et al., U.S. Pat. No. 4,622,277; McVeigh, Jr. et al., U.S. Pat. No. 4,707,421; Batson et al., U.S. Pat. No. 6,001,504; Berkowitz et al., U.S. patent application Ser. No. 10/675,512, filed on Sep. 30, 2003, and entitled “Batteries”; Totir et al., U.S. Pat. application Ser. No. 10/800,905, filed on Mar. 15, 2004, and entitled “Non-Aqueous Electrochemical Cells”; Durkot et al., U.S. Patent Application Publication No. US 2004/0237293 A1, published on Dec. 2, 2004, and entitled “Alkaline Cell With Flat Housing and Nickel Oxyhydroxide Cathode”; and Berkowitz et al., U.S. Patent Application Publication No. US 2005/0112467 A1, published on May 26, 2005, and entitled “Battery Including Aluminum Component”.

A cell (e.g., a cylindrical cell) cari be prepared by, for example, rolling an anode, separator, and cathode together, and placing them in a housing. The housing (containing the anode, the cathode, and the separator) can then be filled with the electrolytic solution and subsequently hermetically sealed with, for example, a cap and annular insulating gasket.

In some embodiments, a cell (e.g., a cylindrical cell) can be prepared by spirally winding an anode, a cathode, and a separator together, with a portion of the cathode current collector extending axially from one end of the roll. The portion of the current collector that extends from the roll can be free of cathode active material. To connect the current collector with an external contact, the exposed end of the current collector can be welded to a metal tab, which is in electric contact with an external battery contact. The grid can be rolled in the machine direction, the pulled direction, perpendicular to the machine direction, or perpendicular to the pulled direction. The tab can be welded to the grid to minimize the conductivity of grid and tab assembly. Alternatively, the exposed end of the current collector can be in mechanical contact (e.g., not welded) with a positive lead which is in electric contact with an external battery contact. A cell having a mechanical contact and not having a welded contact can require fewer parts and steps to manufacture than a cell with a welded contact. In certain embodiments, the effectiveness of the mechanical contact can be enhanced by bending the exposed grid towards the center of the roll to create a dome or crown, with the highest point of the crown over the axis of the roll, corresponding to the center of a cylindrical cell. In the crown configuration, the grid can have a denser arrangement of strands than in the non-shaped form. A crown can be orderly folded and the dimensions of a crown can be precisely controlled.

Methods for assembling electrochemical cells are described, for example, in Moses, U.S. Pat. No. 4,279,972; Moses et al., U.S. Pat. No. 4,401,735; and Kearney et al., U.S. Pat. No. 4,526,846.

### EXAMPLES

The following examples are intended as illustrative and non-limiting.

### Example 1

Five alkaline AA cells (all closed systems) were assembled and tested for burst pressure.

Each alkaline cell was included a steel AA housing having a thickness of 0.25 millimeter. A hole having a 1.0 millimeter diameter was drilled into the positive terminal of each housing (near the rim) and was deburred. Each hole was covered with a 0.001 inch-thick polysulfone film that was adhered to the housing using a mixture of 2.15 parts D.E.R. 325 epoxy resin (from Dow Plastics) and one part Ancamide™ 2426 amidoamine epoxy curing agent (from Air Products).

The following components were then added into each housing: a cathode including electrolytic manganese dioxide (EMD), graphite, and a potassium hydroxide electrolyte, a separator including a cellophane layer and a non-woven layer, and a gelled zinc anode. After all of the components had been added into each housing, the housing was crimped shut to form a cell.

After the cells were formed, they were pressure-tested by drilling another hole into each housing and adding nitrogen gas into each housing through the hole. The nitrogen gas was added into the housing at a controlled rate until the polysulfone film burst, at which point the burst pressure for the cell was determined. The burst pressure was determined using a pressure gauge that measured the nitrogen gas pressure of the hose feeding the nitrogen gas into the housing, as well as the internal pressure of the cell. The burst pressure for each cell is provided in Table 1 below.

TABLE 1

| Cell Number | Membrane Burst Pressure |
|---|---|
| 1 | 805 psi |
| 2 | 825 psi |
| 3 | 910 psi |
| 4 | 815 psi |
| 5 | 1195 psi |

### Example 2

Four sets of alkaline AA cells (with each set including 25 cells) were assembled and tested for burst pressure. Each set of cells had a membrane-covered aperture located in a particular location of the cell housing.

Each alkaline cell included a steel AA housing having a thickness of 0.25 millimeter. A hole (aperture) with a diameter of 1.5 millimeters was drilled and de-burred in a different location of an AA housing for each set of cells. The hole for the Set #1 cells was formed near the crimp of the housing, the hole for the Set #2 cells was formed in the side wall of the housing (in a location between the first and second cathode pellets when the cathode pellets were added into the housing, prior to compaction of the cathode pellets), the hole for the Set #3 cells was formed on the positive terminal near the rim, and the hole for the Set #4 cells was formed on the positive terminal near the pip.

Millennium EN-239-2™ epoxy adhesive (from Resin Technology Group, LLC, South Easton, Mass.) was then added to each hole and cured by exposure to UV radiation. The epoxy adhesive was exposed to UV radiation by passing the AA housing through a Fusion F300 (300 Watt/inch) UV curing system (from Fusion Systems UV, Inc., Gaithersburg, Md.) with an H-bulb at a conveyor belt speed of 10 feet/minute. At this conveyor belt speed, the epoxy adhesive was exposed to UV radiation at 300 Watts per inch for a period of about one second, resulting in the formation of a polymer membrane.

The cells were then assembled by adding the following components into each housing, and crimping each housing to close it after the components had been added: a cathode including electrolytic manganese dioxide (EMD), graphite, and a potassium hydroxide electrolyte, a separator including a cellophane layer and a non-woven layer, and a gelled zinc anode. Each cell also included a nylon vent in its negative terminal assembly.

During assembly and/or storage under ambient conditions, some of the cells leaked. The Set #3 cells, which had the lowest leakage rate (none of the Set #3 cells leaked during cell assembly and two out of the 25 Set #3 cells leaked after eight days of storage under ambient conditions), were selected to be tested for burst pressure.

First, six of the Set #3 cells were subjected to two weeks of a mild temperature-cycling process used to age the cells. During the temperature-cycling process, the cells were cycled between 25° C. and 50° C., one cycle per day. The cells were then pressure-tested by drilling another hole into each housing and adding nitrogen gas into each housing through the hole. The nitrogen gas was added into the housing at a controlled rate until the polymer membrane burst, at which point the burst pressure of cell was determined. The burst pressure was determined using a pressure gauge that measured the nitrogen gas pressure of the hose feeding the nitrogen gas into the housing, as well as the internal pressure of the cell. For each cell, the membrane formed from the Millennium EN-239-2™ epoxy adhesive burst, while the nylon vent did not burst.

The six Set #3 cells had burst pressures of 1260 psi, 1215 psi, 1025 psi,1090 psi, 1230 psi, and 690 psi. The average burst pressure for the six Set #3 cells was 1085 psi, with a standard deviation of 214 psi.

### OTHER EMBODIMENTS

While certain embodiments have been described, other embodiments are possible.

As an example, while batteries including cylindrical housings with apertures and membranes have been described, in some embodiments, a battery can include a non-cylindrical housing that has at least one aperture and/or membrane. For example, in certain embodiments, a battery can include a prismatic housing with at least one aperture and/or membrane.

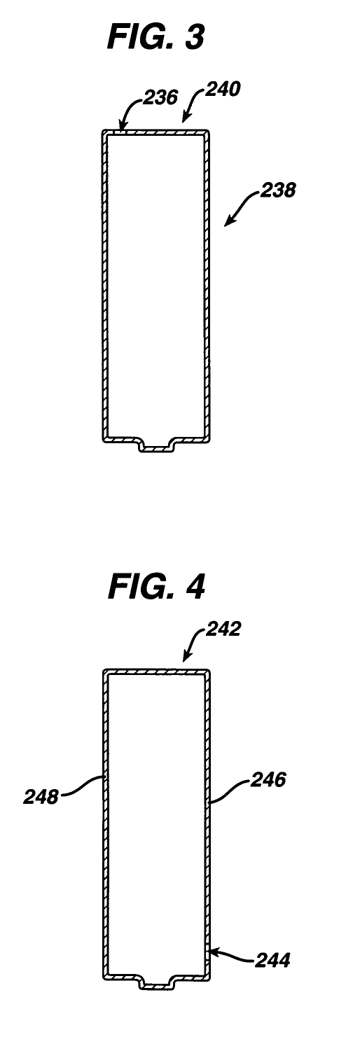

As another example, while positive terminals having apertures and membranes have been described, in certain embodiments, one or more other parts of a battery housing can include at least one aperture and/or membrane. As an example, FIG. 3 shows a battery housing 238 including a negative terminal 240 that has an aperture 236. As another example, FIG. 4 shows a battery housing 242 including an aperture 244 located in the wall 246 of a cylindrical portion 248 of housing 242.

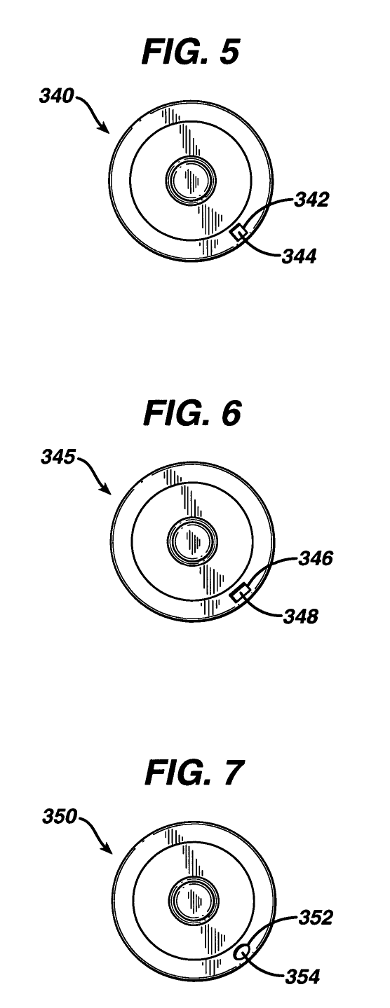

As an additional example, while circular apertures and membranes have been described, in some embodiments, a battery can alternatively or additionally include at least one non-circular aperture and/or non-circular membrane. For example, FIG. 5 shows a positive terminal 340 of a battery. Positive terminal 340 includes a square aperture 342 covered by a square membrane 344. FIG. 6 shows a positive terminal 345 of a battery. Positive terminal 345 includes a rectangular aperture 346 covered by a rectangular membrane 348. FIG. 7 shows a positive terminal 350 of a battery. Positive terminal 350 includes an oval aperture 352 covered by an oval membrane 354.

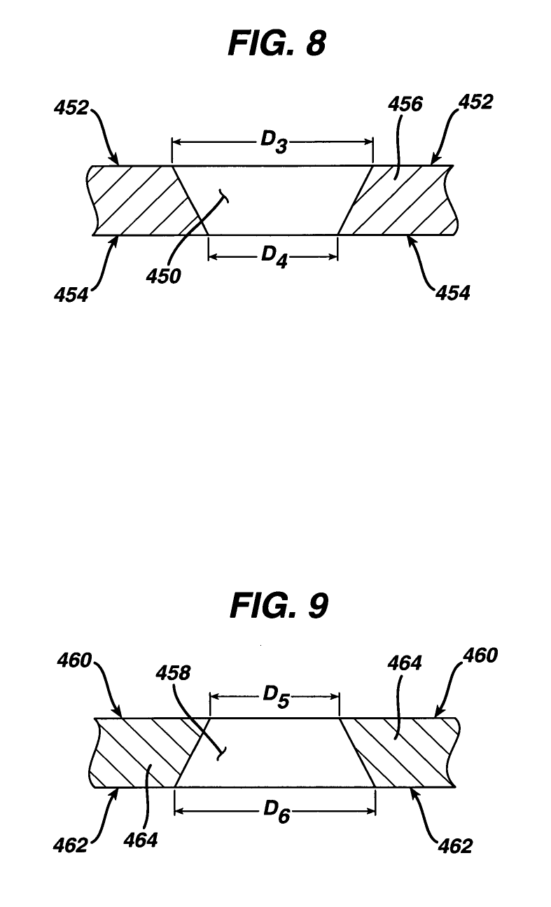

As another example, in some embodiments, a battery housing can include at least one beveled aperture. As an example, FIG. 8 shows a cross-sectional view of a beveled aperture 450 within a battery housing 456. As shown, aperture 450 has a diameter D₃ on the interior side 452 of housing 456 and a smaller diameter D₄ on the exterior side 454 of housing 456. As another example, FIG. 9 shows a cross-sectional view of a beveled aperture 458 within a battery housing 464. As shown, aperture 458 has a diameter D₅ on the interior side 460 of housing 464 and a larger diameter D₆ on the exterior side 462 of housing 464.

In some embodiments, diameter D₄ and/or diameter D₅ can be at most about 0.5 inch (e.g., at most about 0.4 inch, at most about 0.3 inch, at most about 0.2 inch, at most about 0.1 inch, at most 0.05 inch, at most 0.01 inch, at most 0.005 inch) and/or at least 0.001 inch (e.g., at least 0.005 inch, at least 0.01 in, at least 0.05 inch, at least about 0.1 inch, at least about 0.2 inch, at least about 0.3 inch, at least about 0.4 inch). In certain embodiments, diameter D₃ and/or diameter D₆ can be at most about 0.75 inch (e.g., at most about 0.5 inch, at most about 0.25 inch, at most about 0.1 inch, at most 0.05 inch, at most 0.01 inch, at most 0.005 inch) and/or at least 0.001 inch (e.g., at least 0.005 inch, at least 0.01 inch, at least 0.05 inch, at least about 0.1 inch, at least about 0.25 inch, at least about 0.5 inch).

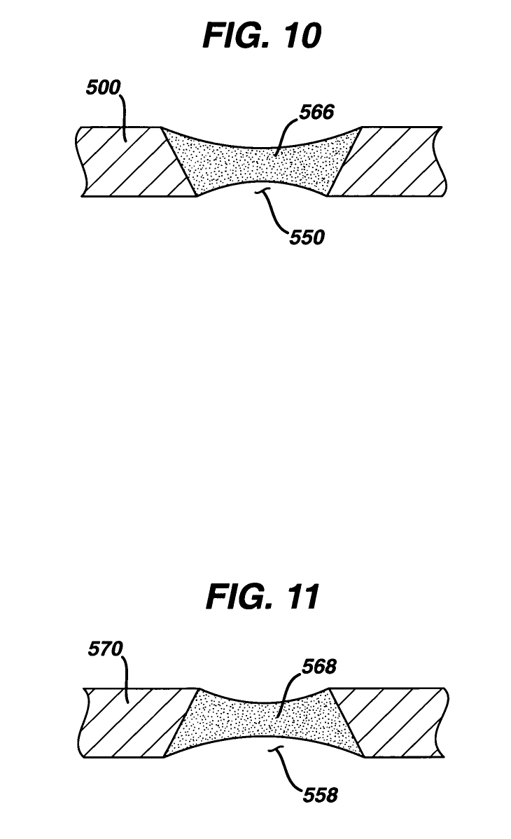

In some embodiments, a beveled aperture can be at least partially (e.g., entirely) filled or covered by a membrane. As an example, FIG. 10 shows a battery housing 500 including a beveled aperture 550 and a membrane 566 filling aperture 550. Membrane 566, which is in the form of a seal, is bonded to the section of housing 500 that defines aperture 550. As another example, FIG. II shows a battery housing 570 including a beveled aperture 558 and a membrane 568 filling aperture 558 and bonded to the section of housing 570 that defines aperture 558. As shown, membrane 568 is in the form of a seal. In certain embodiments, a beveled aperture can provide a relatively large surface area for contact between a membrane filling the aperture and a housing defining the aperture. This relatively large surface area for contact can allow for relatively strong bonding between the membrane and the housing.

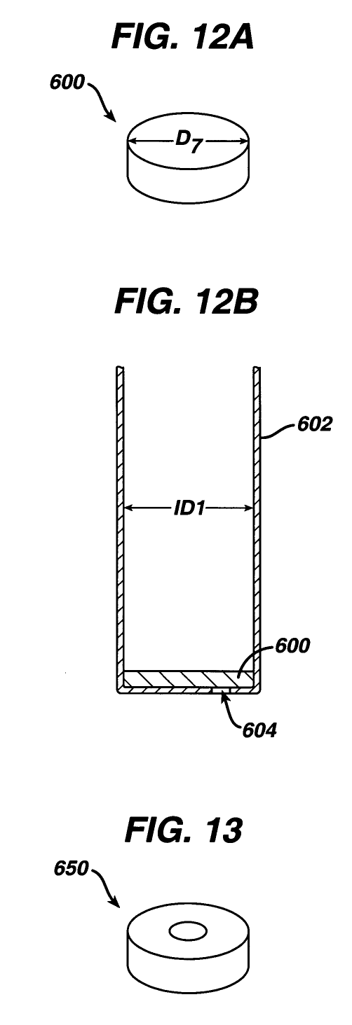

As an additional example, in some embodiments, a membrane can be relatively large. For example, FIG. 12A shows a disk-shaped membrane 600 having a diameter D₇. FIG. 12B shows membrane 600 when membrane 600 has been added into a battery housing 602 having an inner diameter ID1 and including an aperture 604. In some embodiments, membrane 600 may just fit within housing 602 (e.g., diameter D₇ may be almost equal to inner diameter ID 1). As shown in FIG. 12B, membrane 600 covers aperture 604. In certain embodiments, the size of membrane 600 relative to housing 602 can cause membrane 600 to be relatively unlikely to become displaced from its location over aperture 604. In some embodiments, a membrane such as membrane 600 can be relatively easily aligned within a battery housing (e.g., housing 602). In certain embodiments, when the other battery components (e.g., the cathode) are added into housing 602, they can press against membrane 600, thereby helping to hold membrane 600 in place. In some embodiments, membrane 600 can be adhered to housing 602 using a heat-set epoxy and/or a UV-curable binder. While membrane 600 is disk-shaped, a membrane can have any of a number of different shapes. For example, FIG. 13 shows a membrane 650 that is shaped like a washer or a donut, and that can be used to cover one or more apertures in a battery housing.

As another example, while certain methods of forming a membrane in a battery housing have been described, in some embodiments, one or more other methods can be used. Examples of other methods (e.g., for forming a membrane from a polymer) include pad-printing, rolling, drop-casting, spraying, brushing, and pouring methods. For example, in certain embodiments, a pad-printing method can include applying a thin layer of a liquid polymer (e.g., a relatively viscous liquid polymer) to a plate, using a soft rubber pad to pick the polymer off of the plate, and pressing the pad down upon an area including an aperture to deposit the polymer over the aperture. In some embodiments, a pad-printing method can result in the formation of a membrane having a relatively uniform thickness.

As a further example, while battery housings including one membrane have been described, in some embodiments, a battery housing can include multiple different membranes. The different membranes can be formed of different polymer compositions, can have different geometries, and/or can have different dimensions (e.g., diameters). In certain embodiments, the membranes can be in different locations of the battery housing. In some embodiments, during formation of the membranes, the membranes can be cured at different times and/or using different methods (e.g., exposure to ultraviolet (UV) radiation, visible light, heat, and/or electron beam radiation).

As an additional example, in some embodiments, a battery housing can include an inner metal wall and an outer electrically non-conductive material such as heat-shrinkable plastic. In certain embodiments, the battery can also include a layer of conductive material (e.g., disposed between the inner wall of the battery and the cathode of the battery). The layer may be disposed along the inner surface of the inner wall, along the circumference of the cathode, or both. This conductive layer can be formed, for example, of a carbonaceous material (e.g., graphite). Examples of such materials include LB1000 (Timcal), Eccocoat 257 (W.R. Grace & Co.), Electrodag 109 (Acheson Colloids Co.), Electrodag 112 (Acheson), Varniphite 5000 (Nippon), and EB0005 (Acheson). Methods of applying the conductive layer are disclosed, for example, in Canadian Patent No. 1,263,697.

As a further example, in some embodiments, a cathode can include a Co₂ absorption agent. Carbon dioxide absorption agents are described, for example, in Bowden et al., U.S. patent application Ser. No. 11/096,514, filed on Apr. 1, 2005, and entitled “Battery Cathodes”.

All references, such as patent applications publications, and patents, referred to herein are incorporated by reference in their entirety.

Other embodiments are in the claims.

What is claimed is:

1. A battery, comprising:
a housing including an aperture having a first area of at most 0.008 square inch;
an anode in the housing;
a cathode in the housing; and
a membrane covering the aperture, and comprising at least one polymer and having a second area,
wherein the second area is at most about 105 percent of the first area.

2. The battery of claim 1, wherein the first area is at least 0.00002 square inch.

3. The battery of claim 1, wherein the membrane has a thickness of at most 0.03 inch.

4. The battery of claim 1, wherein the membrane has a thickness of at least 0.00005 inch.

5. The battery of claim 1, wherein the membrane is permeable to hydrogen gas.

6. The battery of claim 1, wherein the battery comprises a cylindrical battery.

7. The battery of claim 1, wherein the battery has an internal pressure, and the membrane is adapted to rupture when the internal pressure is at least about 25 psi.

8. The battery of claim 1, wherein the housing comprises a negative terminal including the aperture.

9. The battery of claim 1, wherein the housing comprises a positive terminal including the aperture.

10. A battery, comprising:
a housing including an aperture;
an anode in the housing;
a cathode in the housing; and
a membrane comprising a polymer selected from the group consisting of UV-cured polymers, thermally-cured polymers, and combinations thereof,
wherein the membrane covers the aperture.

11. The battery of claim 10, wherein the membrane comprises a UV-cured polymer.

12. The battery of claim 10, wherein the membrane comprises a thermally cured polymer.

13. The battery of claim 10, wherein the housing comprises a negative terminal including the aperture.

14. The battery of claim 10, wherein the housing comprises a positive terminal including the aperture.

15. A battery, comprising:
a housing including an aperture;
an anode in the housing;
a cathode in the housing; and
a vent assembly comprising a membrane covering the aperture,
wherein the vent assembly does not include a disk.

16. A method of making a battery comprising a housing, the method comprising:
applying a polymer to an aperture in the housing;
curing the polymer to form a membrane covering the aperture;
disposing an anode within the housing; and
disposing a cathode within the housing.

17. The method of claim 16, wherein the housing comprises a negative terminal including the aperture.

18. The method of claim 16, wherein the housing comprises a positive terminal including the aperture.

19. The method of claim 16, wherein the polymer comprises a UV-curable polymer.

20. The method of claim 16, wherein the polymer comprises a thermally-curable polymer.

21. The method of claim 20, wherein the thermally curable polymer comprises a polymer selected from the group consisting of oxetane, epoxy, and combinations thereof.

22. The method of claim 16, wherein curing the polymer comprises applying UV radiation to the polymer.

23. The method of claim 16, wherein curing the polymer comprises heating the polymer to a temperature of at least about 25° C.

24. The method of claim 16, further comprising forming the aperture in the housing.
